(19) United States
(12) Patent Application Publication
(10) Pub. No.: US 2024/0390203 A1
(43) Pub. Date: Nov. 28, 2024

(54) INTEGRATED PRESSURE SENSING AND REDISTRIBUTION FOR OPERATING TABLE PADS

(71) Applicant: Baxter Medical Systems GmbH + Co. KG, Saalfeld (DE)

(72) Inventors: Heinz-Hermann Dalbert, Charleston, SC (US); Steffen Löser, Unterwellenborn (DE); Nicolette D. Sizer, Nottingham (GB); Julia Sabrina Fleischer, Winterthur (CH); Pascal Stark, St. Gallen (CH); Philip Breedon, ILKESTON (GB); Bronek Boszczyk, Kolbermoor (DE)

(73) Assignees: Baxter Medical Systems GmbH + Co. KG, Saalfeld (DE); Nottingham Trent University, Nottingham (GB)

(21) Appl. No.: 18/671,450

(22) Filed: May 22, 2024

Related U.S. Application Data
(60) Provisional application No. 63/468,069, filed on May 22, 2023.
(60) Provisional application No. 63/468,068, filed on May 22, 2023.

(51) Int. Cl. A61G 7/057; G01L 1/18

(52) U.S. Cl. CPC A61G 7/05769; A61G 2203/10; A61G 2203/34; A61G 2210/50; G01L 1/18

(57) ABSTRACT

A patient table includes a patient support surface for supporting a patient and a pressure redistribution assembly that includes a pressure sensing assembly and a repositioning assembly. The pressure sensing assembly measures a pressure between the patient support surface and a patient at a plurality of sensing regions. The repositioning assembly includes a plurality of inflatable cells overlapping the plurality of sensing regions. A medium is located within the inflatable cells and an actuator selectively redistributes a quantity of the medium between the inflatable cells. A processor is configured to receive a measurement of the pressure from the pressure sensing assembly, determine if the measurement of pressure is above a threshold and, if the measurement of pressure is above the threshold, generate a signal to redistribute the medium.

### CROSS-REFERENCE TO RELATED APPLICATIONS

This application claims priority under U.S.C. § 119 (e) to U.S. Provisional Application No. 63/468,069 filed on May 22, 2023, entitled “INTEGRATED PRESSURE SENSING AND REDISTRIBUTION FOR OPERATING TABLE PADS,” and U.S. Provisional Application No. 63/468,068 filed on May 22, 2023, entitled “INTEGRATED PRESSURE SENSING AND REDISTRIBUTION FOR OPERATING TABLE PADS,” the disclosures of which are hereby incorporated by reference in their entireties.

### FIELD OF THE DISCLOSURE

The present disclosure generally relates to a pressure redistribution assembly and, more particularly, to a pressure redistribution assembly for a patient.

### SUMMARY OF THE DISCLOSURE

According to one aspect of the present disclosure, a patient table includes a patient support surface for supporting a patient and at least one pressure redistribution assembly. Each of the at least one pressure redistribution assembly includes a pressure sensing assembly and a repositioning assembly. The pressure sensing assembly is located proximate to the patient support surface to measure a pressure between the patient support surface and a patient at a plurality of sensing regions. The repositioning assembly includes a plurality of inflatable cells overlapping the plurality of sensing regions. A medium is located within the inflatable cells, and an actuator selectively redistributes a quantity of the medium between the inflatable cells. A processor and a memory contains instructions that, when executed by the processor, cause the processor to receive a measurement of the pressure from the pressure sensing assembly. The processor is further caused to determine if the measurement of pressure is above a threshold and, if the measurement of pressure is above the threshold, generate a signal to redistribute the medium.

According to another aspect of the present disclosure, a pressure redistribution assembly for a patient includes a pressure sensing assembly and a repositioning assembly. The pressure sensor assembly includes a pair of conductive layers and a piezo-resistive layer sandwiched between the pair of conductive layers. Each conductive layer defines a plurality of conductive pathways that overlap to form a matrix of sensing regions. The repositioning assembly includes a plurality of inflatable cells overlapping the sensing regions, a medium located within the inflatable cells, and an actuator that selectively redistributes a quantity of the medium between the inflatable cells.

According to yet another aspect of the present disclosure, a cushion for a patient in an operating environment includes an outer envelope surrounding the cushion and a patient support surface is defined by a portion of the outer envelope. The cushion includes a pressure redistribution assembly located in the outer envelope. The pressure redistribution assembly includes a pressure sensing assembly and a repositioning assembly. The pressure sensing assembly includes a pair of conductive layers and a piezo-resistive layer sandwiched between the pair of conductive layers. Each conductive layer defines a plurality of conductive pathways that overlap to form a matrix of sensing regions. The repositioning assembly includes a plurality of piezo-electric actuators overlapping the sensing regions that expand and contract from an applied voltage.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1A is a front perspective view of a first patient table including a pressure redistribution assembly according to an aspect of the present disclosure;

FIG. 1B is a front perspective view of a second patient table including a pressure redistribution assembly according to an aspect of the present disclosure;

FIG. 2A is a top view of a pressure redistribution assembly having a first outer perimeter shape according to an aspect of the present disclosure;

FIG. 2B is a top view of a pressure redistribution assembly having a second outer perimeter shape according to an aspect of the present disclosure;

FIG. 2C is a top view of a pressure redistribution assembly having a third outer perimeter shape according to an aspect of the present disclosure;

FIG. 3A is a cross-sectional view of a pressure redistribution assembly having a first construction according to an aspect of the present disclosure;

FIG. 3B is a cross-sectional view of a pressure redistribution assembly having a second construction according to an aspect of the present disclosure;

FIG. 4A is a cross-sectional view of a pressure redistribution assembly in a first location with respect to a cushion according to an aspect of the present disclosure;

FIG. 4B is a cross-sectional view of a pressure redistribution assembly in a second location with respect to a cushion according to an aspect of the present disclosure;

FIG. 4C is a cross-sectional view of a pressure redistribution assembly in a third location with respect to a cushion according to an aspect of the present disclosure;

FIG. 4D is a cross-sectional view of a pressure redistribution assembly in a fourth location with respect to a cushion according to an aspect of the present disclosure;

FIG. 5A is a top view of a cushion that includes a plurality of pressure redistribution assemblies according to an aspect of the present disclosure;

FIG. 5B is a side view of a cushion that includes a plurality of pressure redistribution assemblies according to an aspect of the present disclosure;

FIG. 6 is a disassembled perspective view of a pressure redistribution assembly according to an aspect of the present disclosure;

FIG. 7A is a front view of a display visualizing a first pressure distribution in a matrix pattern according to an aspect of the present disclosure;

FIG. 7B is a front view of a display visualizing a second pressure distribution in a matrix pattern according to an aspect of the present disclosure; and

FIG. 8 is a schematic view of a control system according to an aspect of the present disclosure.

### DETAILED DESCRIPTION

The present illustrated embodiments reside primarily in combinations of method steps and apparatus components related to a pressure redistribution assembly for a patient. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

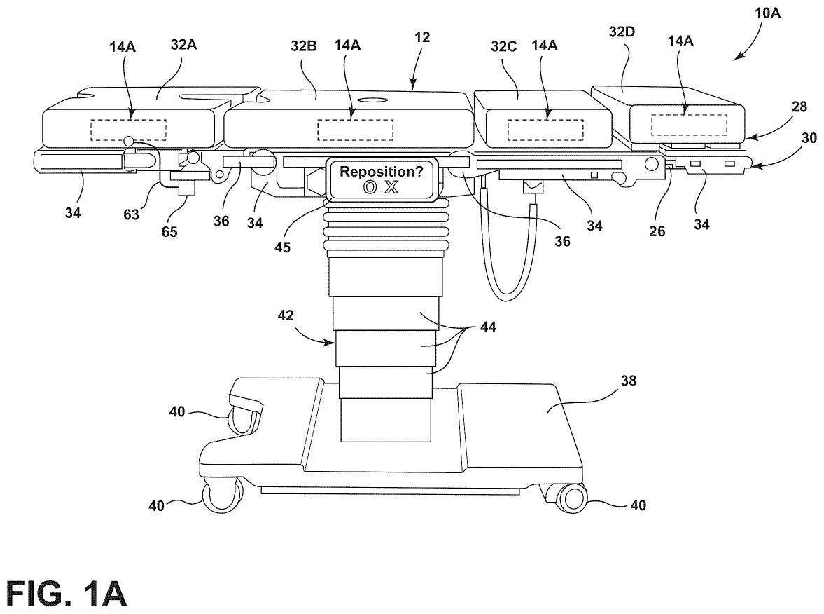

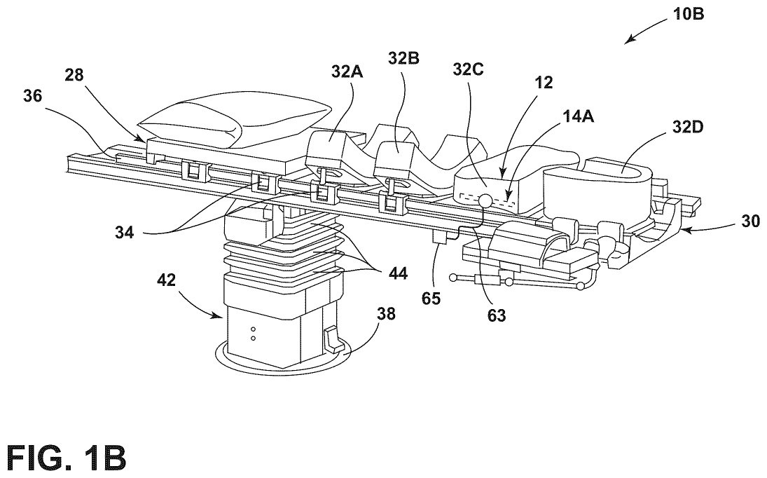

For purposes of description herein, the terms “upper,” “lower,” “right,” “left,” “rear,” “front,” “vertical,” “horizontal,” and derivatives thereof, shall relate to the disclosure as oriented in FIG. 1A. Unless stated otherwise, the term “front” shall refer to a surface closest to an intended viewer, and the term “rear” shall refer to a surface furthest from the intended viewer. However, it is to be understood that the disclosure may assume various alternative orientations, except where expressly specified to the contrary. It is also to be understood that the specific structures and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

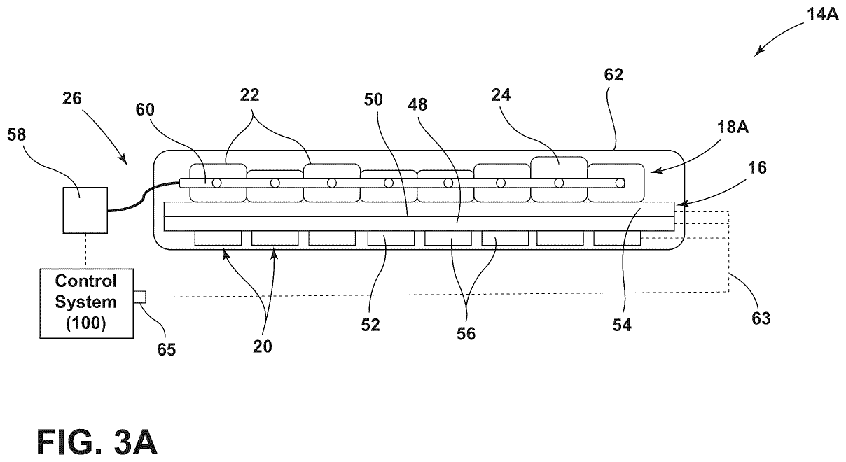

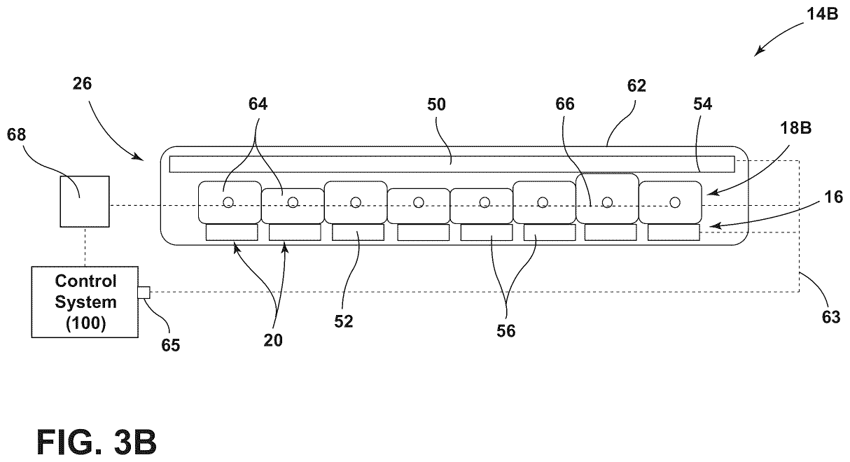

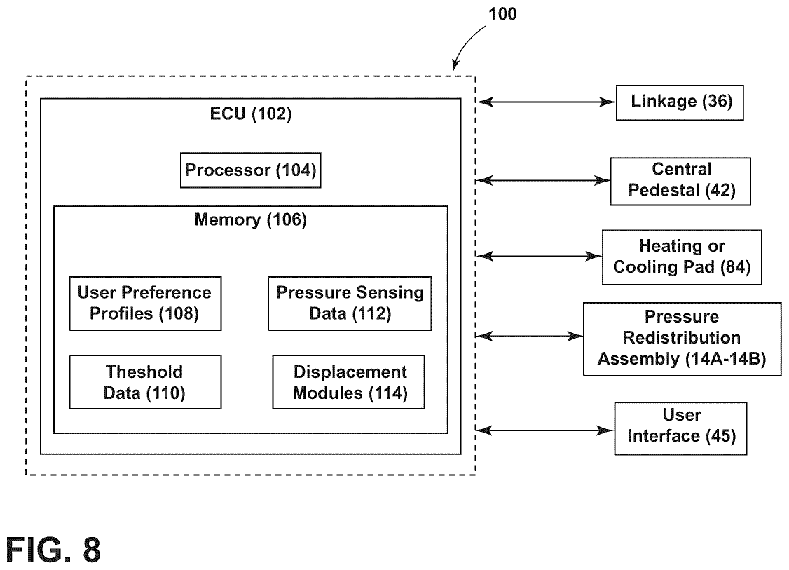

Referring to FIGS. 1A, 2A-3A, reference numeral 10A generally designates a patient table under a first arrangement. The patient table 10A includes a patient support surface 12 for supporting a patient and at least one pressure redistribution assembly 14A. Each of the at least one pressure redistribution assembly 14A includes a pressure sensing assembly 16 and a repositioning assembly 18A (FIG. 3A). The pressure sensing assembly 16 is located proximate to the patient support surface 12 to measure a pressure between the patient support surface 12 and a patient at a plurality of sensing regions 20. The repositioning assembly 18A under a first construction may include a plurality of adjustable actuators (e.g., a plurality of inflatable cells 22) overlapping (e.g., each aligned) with one of the plurality of sensing regions 20. A medium 24 is located within the inflatable cells 22 and an actuator 26 selectively redistributes a quantity of the medium 24 between the inflatable cells 22. A control system 100 (FIG. 8) includes a processor 104 and a memory 106 containing instructions that, when executed by the processor 104, cause the processor 104 to receive a measurement of the pressure from the pressure sensing assembly 16. The processor 104 is further caused to determine if the measurement of pressure is above a threshold and, if the measurement of pressure is above the threshold, generate a signal to redistribute the medium 24.

With reference now to FIG. 1A, the patient table 10A includes a patient support mattress 28 and a mattress support frame 30 that supports and positions the patient support mattress 28. In some embodiments, the patient support mattress 28 includes two or more (e.g., three, four, five, or six) cushions 32A-32D and the mattress support frame 30 may include two or more sub-support frames 34 (e.g., three, four, five, or six). The sub-support frames 34 may be operably coupled by linkages 36 that permit articulation between adjacent sub-support frames 34 to position the cushions 32A-32D and, by extension, the patient in varying orientations. The patient table 10A further includes a base frame 38 that may include a plurality of caster wheels 40 that allow the patient table 10A to roll between different locations in a medical facility (e.g., along an X-axis and a Z axis). A central pedestal 42 operably connects the base frame 38 to the mattress support frame 30. The central pedestal 42 may be vertically (e.g., along a Y-axis) adjustable between a variety of positions to suit the needs of a caregiver. More particularly, the central pedestal 42 may include a series of telescopically adjustable sleeves 44. In some embodiments, the central pedestal 42 connects centrally on the base frame 38 between the caster wheels 40 and centrally on the mattress support frame 30, such that a patient's center of mass is substantially aligned therewith. In some embodiments, a central wheel (not shown) may be located under the central pedestal 42 to facilitate movement around the medical facility. The central wheel may be driven via a motor, and/or the like, and moveable between an operating position and a stowed position. In some embodiments, the patient bed 10A may include a user interface 45, which may transmit and receive instructions or information about the pressure redistribution assembly 14A and other components of the patient table 10A. In some embodiments, the patient table 10A may be configured as a patient operating table, such that it is used during therapy, surgery, and/or the like. However, it should be appreciated that, in other embodiments, the patient table 10A may be configured as a long-term patient bed or resting surface.

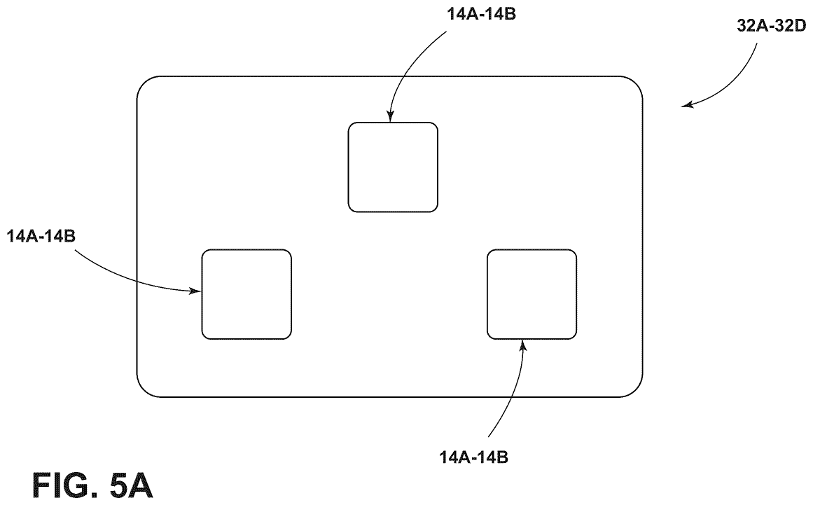

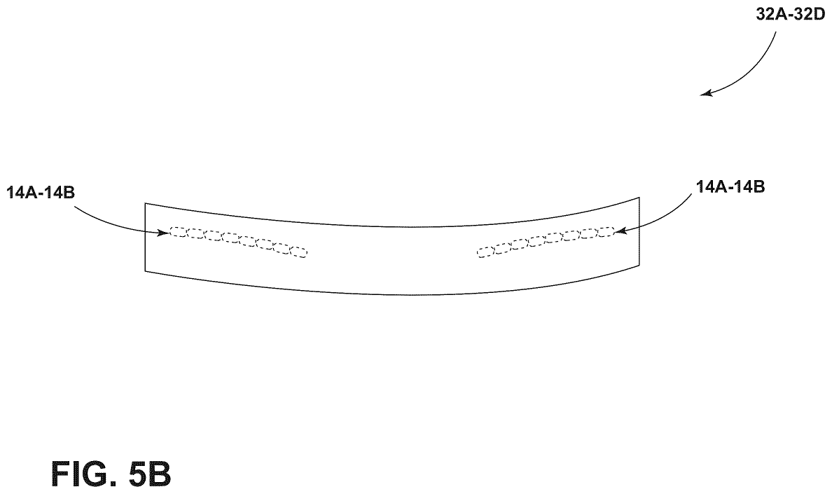

With reference now to FIG. 1B, a patient operating table 10B under a second arrangement may be configured for spinal surgery. The patient operating table 10B may include all the same features, functions, and materials as the patient operating table 10A of the first arrangement. However, the patient operating table 10B includes cushions 32A-32D having a modified shape that alters the patient support surface 12. More particularly, at least some of the cushions 32A-32D may define an arch-shaped upper surface such that the patient support surface 12 effectively cradles the patient as the patient lays face forward towards the patient support surface 12. Each or select of the cushions 32A-32D may include at least one pressure redistribution assembly 14A. In some embodiments, at least cushions 32B-32D each include at least one pressure redistribution assembly 14A. For example, the cushion 32B may include a pair of pressure redistribution assemblies 14A aligned with the patient's hips, the cushion 32C may include one or more pressure redistribution assemblies 14A aligned with the patient's chest, and the cushion 32D may include one or more pressure redistribution assemblies 14A aligned with the patient's head (FIG. 5B). In this manner, micro-adjustments of pressure redistribution assemblies 14A reposition pressure on the patient's body without significant movement. Such, an arrangement may be particularly beneficial to spinal surgery applications as spinal surgery is oftentimes a time-intensive process where significant movement of the patient is not possible. In addition, some of the cushions 32A-32D, such as cushion 32B may be more narrow than the cushions 32A-32D in the patient operating table 10A of the first arrangement and thus a greater amount of pressure may be generated between the patient and the patient support surface 12. Each or select ones of the cushions 32A-32D may be located on sub-support frames 34 that are slidable on the support frame 30 with linkages 36 to adjust the cushions 32A-32D to different sized patients.

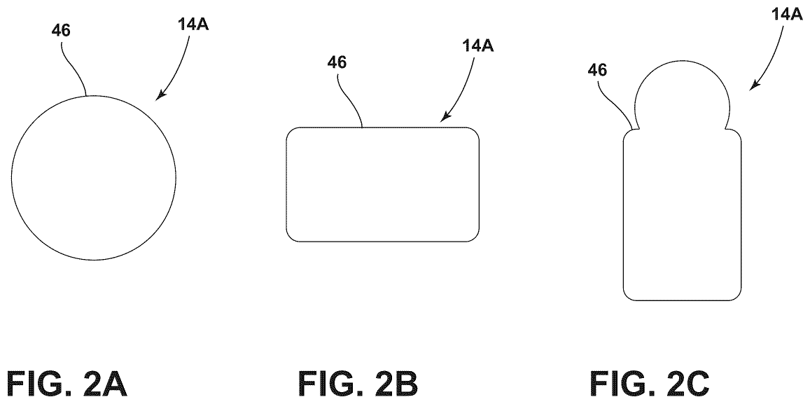

With reference now to FIGS. 2A-2C, the pressure redistribution assembly 14A may include an outer perimeter 46 defining a surface area that the repositioning assembly 18A can shift pressure between the patient and the patient support surface 12. The outer perimeter 46 may have a variety of shapes. With reference to FIG. 2A, the outer perimeter 46 may define one or more curves, such as a circular or oval shape. As such, the repositioning assembly 18A can shift pressure between the patient and the patient support surface 12 within a circular or oval area. Such shapes may be beneficial for shifting pressure from limbs of the patient, shoulders, head, and/or the like. With reference now to FIG. 2B, the outer perimeter 46 may define one or more straight edges, such as a rectangle or square. As such, the repositioning assembly 18A can shift pressure between the patient and the patient support surface 12 within a rectangular, square, area of other shapes. Such shapes may be beneficial for shifting pressure from the limbs of the patient, torso, head, and/or the like. With reference now to FIG. 2C, the outer perimeter 46 may define one or more portions of a human body. As such, the repositioning assembly 18A can shift pressure between the patient and the patient support surface 12 within areas that match a body part of the patient, such as head, torso, limbs, or a combination thereof. Such shapes may be beneficial for shifting pressure for one or more specific regions of the body. In some embodiments, more than one repositioning assembly 14A is located within the outer perimeter 46.

With reference now to FIG. 3A, the pressure redistribution assembly 14A includes the repositioning assembly 18A under the first construction. Under the first construction, as described previously, the repositioning assembly 18A includes the plurality of inflatable cells 22 overlapping (e.g., each aligned) with one of the plurality of sensing regions 20. The medium 24 is located within the inflatable cells 22, and an actuator 26 selectively redistributes a quantity of the medium 24 between the inflatable cells 22. The medium 24 may include air, liquid, or gel. The pressure sensing assembly 16 may include a piezo-resistive layer 48, a top conductive layer 50, and a bottom conductive layer 52. The piezo-resistive layer 48 may be located between the top conductive layer 50 and the bottom conductive layer 52. The top conductive layer 50 includes a plurality of rows of conductive pathways 54 (e.g., traces) and the bottom conductive layer 52 includes a plurality of columns of conductive pathways 56 (e.g., traces). The plurality of rows of conductive pathways 54 extend transverse to the plurality of columns of conductive pathways 56 and overlap to form the sensing regions 20. The sensing regions 20 may, therefore, be arranged in a scalable, matrix-like pattern defined by the overlapping conductive pathways 54, 56. The plurality of rows of conductive pathways 54 may include five (5) or more rows and the plurality of columns of conductive pathways may include five or more columns defining at least twenty-five (25) sensing regions. In some embodiments, the number of rows may be equal to the number of columns. In some embodiments, the number of rows may be less than or equal to the number of columns. For example, the plurality of rows of conductive pathways 54 may include eight (8) or more rows and the plurality of columns of conductive pathways 56 may include eight (8) or more columns defining at least sixty-four (64) sensing regions 20. In some embodiments, the plurality of rows of conductive pathways 54 extend perpendicularly to the plurality of columns of conductive pathways 56 and overlap to form the sensing regions 20.

With continued reference to FIG. 3A, the number of inflatable cells 22 may be equal or unequal to the number of the sensing regions 20. For example, each of the sensing regions 20 may include a single one of the inflatable cells 22 aligned therewith. However, in some embodiments, the sensing regions 20 may not be aligned with the inflatable cells 22, overlapping in alignment, overlapping in non-aligned relationship, overlapping in a staggered relationship, and/or the like. In this manner, the inflatable cells 22 can be specifically actuated based on the pressure between the patient support surface 12 and the patient at a particular sensing region 20. The actuator 26 in the repositioning assembly 18A may include a pump 58 and a manifold 60 of medium pathways. The medium pathways in the manifold 60 may be fluidically connected to each of the inflatable cells 22. The manifold 60 (e.g., via the pump 58) may be configured to add the medium 24 to each of the inflatable cells 22. In some embodiments, the manifold 60 (e.g., via the pump 58) may be further configured to remove the medium 24 from each of the inflatable cells 22. In this manner, the actuator 26 can distribute and redistribute the medium 24 between each of the inflatable cells 22. The pressure redistribution assembly 14A may be entirely or partially located in an outer wrapper 62. In some embodiments, the outer wrapper 62 may be hermetically sealed. For example, in some embodiments, the pressure sensing assembly 16 and the repositioning assembly 18A may be located in the outer wrapper 62 and one or both of the actuator 26 and the control system 100 may be located outside of the outer wrapper 62. As will be described in further detail below, in some embodiments, the control system 100 may be located in the outer wrapper 62 or, otherwise, proximate the outer wrapper 62 and issue commands only to the pressure redistribution assembly 14A. In other embodiments, the control system 100 may be configured as a global control system that issues commands to more than one pressure redistribution assembly 14A and other features of the patient table 10A, 10B. In some embodiments, the control system 100 (e.g., the global control system 100) is coupled to (e.g., connected to, located in, located on) the patient table 10A, 10B and a power conduit 63 may extend through the outer wrapper 62 and be operably connected to the control system 100. More particularly, the patient table 10A, 10B may include at least one outlet port 65 that connects the redistribution assembly 14A (e.g., the power conduit 63) to the control system 100 for the transmission of power and operation instructions. In some embodiments, the power conduit 63 is hermetically sealed (e.g., via a gasket, an adhesive, epoxy, and/or the like) to the outer wrapper 62. In some embodiments, the at least one output port 65 may be configured to connect to a plurality of power conduits 63 of more than one redistribution assembly 14A. In some embodiments, the at least one output port 65 may include a plurality of output ports 65 to connect to the power conduits 63 of more than one redistribution assembly 14A.

With reference now to FIG. 3B, a pressure redistribution assembly 14B includes the repositioning assembly 18B under a second construction. Under the second construction, the pressure redistribution assembly 14B may include all the same features, structures, materials, and functionalities of the first construction. However, rather than including inflatable cells 22, the repositioning assembly 18B relies on a piezo-electric effect to reposition the pressure distribution. More particularly, the piezo-resistive layer 48 may include a plurality of piezo-electric actuators 64 located in the same general position as the inflatable cells 22 in the first construction. The piezo-electric actuators 64 may be configured to expand and contract with an applied voltage. An electrical circuit 66 may extend to a power supply 68 and/or directly to the control system 100. The electrical circuit 66 may include the power conduit 63. In some embodiments, the control system 100 (e.g., the global control system 100) is coupled to (e.g., connected to, located in, located on) the patient table 10A, 10B and the power conduit 63 may extend through the outer wrapper 62 and be operably connected to the control system 100. More particularly, the patient table 10A, 10B may include the at least one outlet port 65 that connects the redistribution assembly 14B (e.g., the power conduit 63) to the control system 100 for the transmission of power and operation instructions. In some embodiments, the power conduit 63 is hermetically sealed (e.g., via a gasket, an adhesive, epoxy, and/or the like) to the outer wrapper 62. In some embodiments, the at least one output port 65 may be configured to connect to a plurality of power conduits 63 of more than one redistribution assembly 14B. In some embodiments, the at least one output port 65 may include a plurality of output ports 65 to connect to the power conduits 63 of more than one redistribution assembly 14B.

With reference to FIGS. 3A and 3B, it is contemplated that adjustable actuators other than the inflatable cells 22 and piezo-electric actuators 64 may be implemented in the redistribution assemblies 14A, 14B under the first or second constructions. The example, the adjustable actuators may incorporate any material or assembly that expands and contracts based on an applied voltage, pneumatic technologies, electromagnetic technologies, and/or the like. Likewise, it should be appreciated that the pressuring sensing assembly 16 may include any material or assembly that measures pressure imparted by a patient. For example, the pressure sensors 52 may be configured as strain sensors, capacitive sensors, and/or other types of pressure sensors.

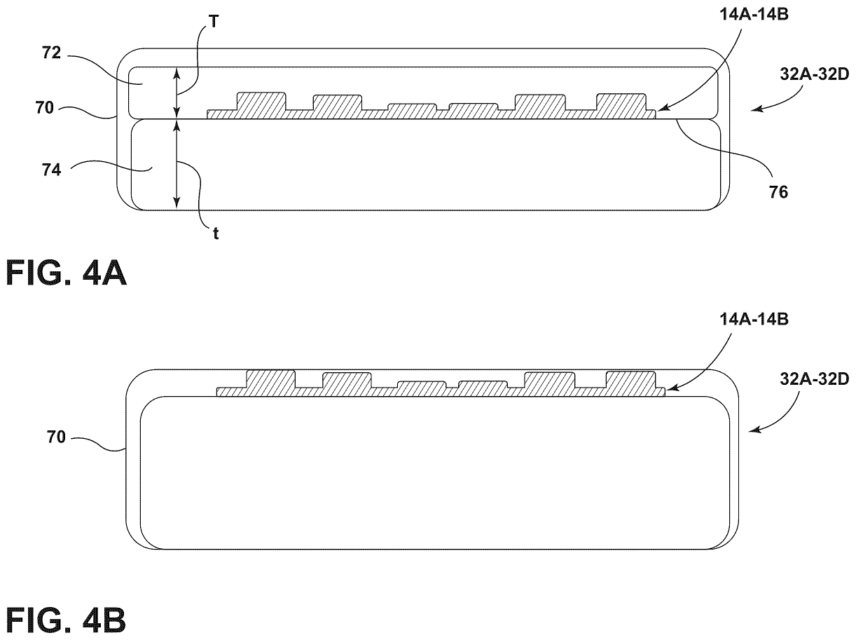

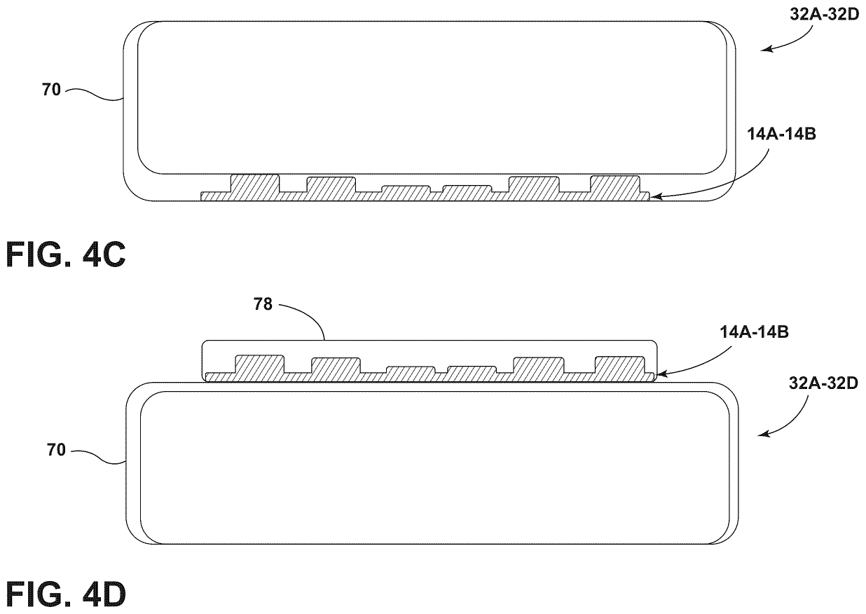

With reference now to FIGS. 4A-4D, the pressure redistribution assembly 14A, 14B may be proximate to each cushion 32A-32D, such as the cushions 32A-32D illustrated in FIGS. 1A-3B. An outer envelope 70 (e.g., the outer wrapper 62) may surround one or more cushions 32A-32D. In some embodiments, the pressure redistribution assembly 14A, 14B may be located in the outer envelope 70. However, it should be appreciated that, in other embodiments, the pressure redistribution assembly 14A, 14B may be located outside of the outer envelope 70.

With reference now to FIG. 4A, the cushion 32A-32D may include an upper cushion layer 72 located proximate to the patient support surface 12 and a lower cushion layer 74 spaced from the patient support surface 12 by the upper cushion layer 72. The pressure redistribution assembly 14A, 14B may be located between the upper cushion layer 72 and the lower cushion layer 74. The upper cushion layer 72 may be adhered to the lower cushion layer 74 with an adhesion layer 76. The upper cushion layer 72 may define a first thickness “T” and the lower cushion layer 74 may define a second thickness “t” that is greater than the first thickness T. In some embodiments, the pressure redistribution assembly 14A, 14B includes two or more pressure redistribution assemblies 14A, 14B located in the cushion 32A-32D. In some embodiments, two or more of the cushions 32A-32D of the patient table 10A, 10B include at least one of the pressure redistribution assembly 14A, 14B.

With reference now to FIG. 4B, the pressure redistribution assembly 14A, 14B may be located on a top surface of the cushion 32A, 32D. For example, the pressure redistribution assembly 14A, 14B may be located between the top surface of the cushion 32A, 32D and the outer envelope 70. With reference now to FIG. 4C, the pressure redistribution assembly 14A, 14B may be located on a bottom surface of the cushion 32A, 32D. For example, the pressure redistribution assembly 14A, 14B may be located between the bottom surface of the cushion 32A, 32D and the outer envelope 70.

With reference now to FIG. 4C, the pressure redistribution assembly 14A, 14B may be located outside of the outer envelope 70. For example, the pressure redistribution assembly 14A, 14B may be located in the outer wrapper 62 and be configured to move independently relative to the cushion 32A, 32D and other features of the patient table 10A, 10B. In this manner, the location and number of the one or more of the pressure redistribution assemblies 14A, 14B can be reconfigured based on patient or provider needs including locations other than the patient table 10A, 10B. In some embodiments, at least one pad 78 is located in the outer wrapper 62 over and/or under the pressure redistribution assembly 14A, 14B.

With reference now to FIGS. 5A and 5B, the cushions 32A-32D, such as those described in reference to FIGS. 1A-4D, may include a plurality of the pressure redistribution assemblies 14A, 14B. The pressure redistribution assemblies 14A, 14B may be located to match areas of risk in the patient body that are susceptible to circulation issues, bed sores, and/or the like. It should be appreciated that the cushions 32A-32D and/or the pressure redistribution assembly 14A, 14B may be utilized in structures other than the patient table 10A, 10B. For example, patient tables other than the patient table 10A, 10B may utilize the cushions 32A-32D and/or the pressure redistribution assembly 14A, 14B. The other patient tables may include patient tables that are configured to allow a patient to rest on their back, stomach, or sides. The other patient tables may be configured for long-term patient care (e.g., a hospital bed) or short-term care (e.g., a patient operating table). In some embodiments, a chair may utilize the cushions 32A-32D and/or the pressure redistribution assembly 14A, 14B (e.g., for the back and/or seat). The cushion 32A-32D in FIG. 5B may have a similar configuration to the cushions 32A, 32B illustrated in FIG. 1B and be configured to support a patient during spinal surgery. The pressure redistribution assemblies 14A, 14B may be located to support opposite sides of the patient's hips.

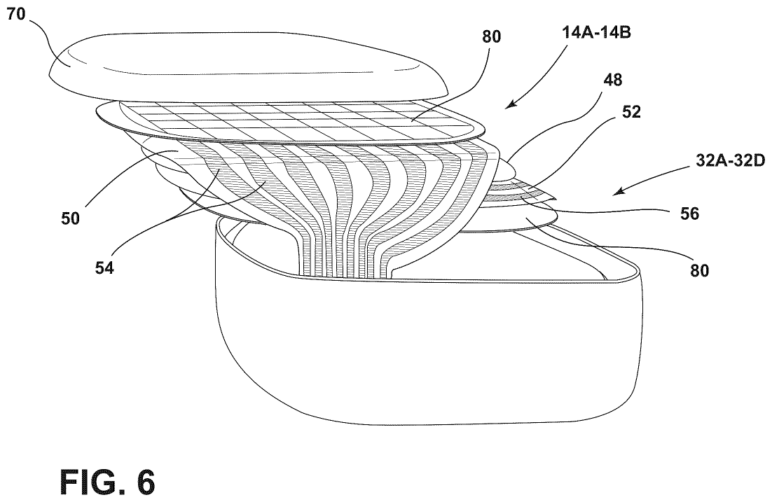

With reference now to FIG. 6, the pressure redistribution assembly 14A, 14B is illustrated with the piezo-resistive layer 48, the top conductive layer 50, and the bottom conductive layer 52 in a disassembled state. In some embodiments, the plurality of rows of conductive pathways 54 and the plurality of columns of conductive pathways 56 may each define a closed conduction loop. The pressure redistribution assembly 14A, 14B may further include a pair of protective layers 80 located on opposite sides of the piezo-resistive layer 48, the top conductive layer 50, and the bottom conductive layer 52. The components of the pressure redistribution assembly 14A, 14B may be semi-flexible. In this manner, the pressure redistribution assembly 14A, 14B may determine a pressure between two rigid surfaces, two non-rigid surfaces (e.g., memory foam or the body of the patient), or a rigid and a non-rigid surface. In addition to the sensing regions 20 arranged in a scalable, matrix-like pattern, each sensing region 20 may be individually scalable based on the overlapping surface area between the conduction layers 50, 52. In some embodiments, the area of the sensing regions 20 is less than 1 cm2, for example, about 0.5 cm by 0.5 cm. In some embodiments, the pressure redistribution assembly 14A, 14B is substantially radiolucent so as not to interfere with X-rays and other types of medical imaging systems. For example, the top conductive layer 50 and the bottom conductive layer 52 may be formed of stretchable fabric (e.g., woven) with the conductive pathways 54, 56. The piezo-resistive layer 48 may also be flexible and partially formed of one or more fabrics, such as, cotton, spandex, nylon, and/or the like, with sections of piezo-resistive material aligned with each sensing region 20. The piezo-resistive material may be a transparent semiconductor material, such as a transparent oxide semiconductor (“TCO”). Each of the conductive pathways 54, 56 may exhibit detectable changes when exposed to pressure from a patient (e.g., changes in resistivity, capacitance, and/or the like). Because the conductive pathways 54, 56 overlap into the matrix-like pattern, the detection in sensing regions 20 can be extrapolated via the control system 100 by detecting and corresponding the changes in the conductive pathways 54, 56 to specific overlapped regions (e.g., the sensing regions 20).

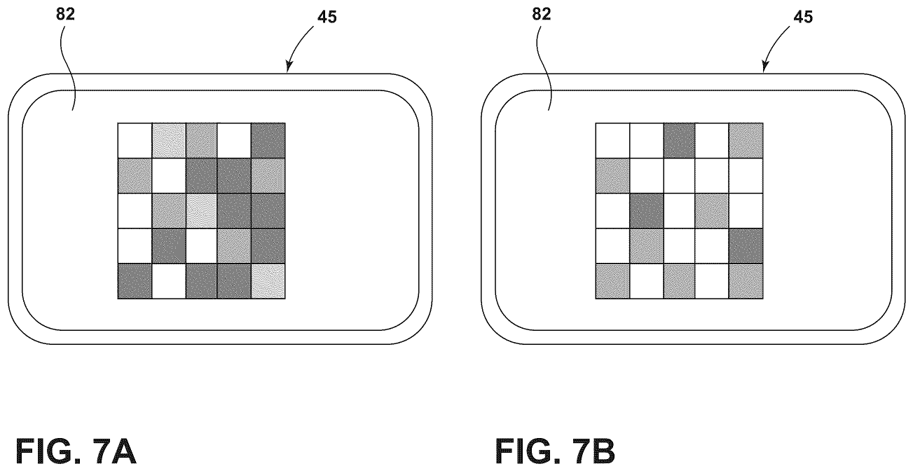

With reference now to FIGS. 7A and 7B, the user interface 45 may transmit and receive instructions or information about the pressure redistribution assembly 14A, 14B and other components of the patient table 10A, 10B. For example, the user interface 45 may include a display 82 that visualizes the pressure distribution across the matrix of sensing regions 20. The user interface 45 may include various user inputs, such as buttons, touch screen, remotes, and/or the like. As such, the user interface 45 may be configured to transmit a signal to the actuator 26 via inputs from the user inputs. However, in some scenarios, the control system 100 may automatically generate a signal to the actuator 26 without requiring manual user inputs. In some embodiments, the visualization of the pressure distribution may be generated based on a predetermined threshold, such as a magnitude of pressure threshold or a period of time that the measurement of pressure is above the magnitude of pressure threshold. In some embodiments, the display 82 is configured as a touch screen allowing the provider or patient to adjust the pressure distribution on a micro, per sensing region 20, basis. For example, touching one of the generated sensing regions 20 may allow adjustment to the inflatable cell 22 or the piezo-electric actuators 64 associated with the sensing region 20. The sensing regions 20 may be generated with various colors, tone, hues, intensities, numbers, and/or other indicia that notify the provider or patient of the sensed pressure from any particular sensing region 20. In some embodiments, the user interface 45 may also command certain operations associated with the patient table 10A, 10B, for example, the linkages 36 that permit articulation between adjacent sub-support frames 34, the telescopically adjustable central pedestal 42, and/or the like. In some embodiments, a heating or cooling pad 84 (FIG. 8) may be aligned with the pressure redistribution assembly 14A, 14B and modify a temperature of the support surface 12 to encourage circulation or comfort of the patient based on the sensed pressure.

With reference to FIG. 8, the control system 100 may include an electronic control unit (ECU) 102. The ECU 102 may include a processor 104 and a memory 106. The processor 104 may include any suitable processor 104. Additionally, or alternatively, the ECU 102 may include any suitable number of processors, in addition to or other than the processor 104. The memory 106 may comprise a single disk or a plurality of disks (e.g. hard drives) and includes a storage management module that manages one or more partitions within the memory 106. In some embodiments, memory 106 may include flash memory, semiconductor (solid-state) memory, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the patient operating table 10A, 10B and/or one or more of the pressure redistribution assembly 14A, 14B. For example, the linkages 36, the telescopically adjustable central pedestal 42, the user interface 45, the heating or cooling pad 84, and one or more of the pressure redistribution assembly 14A, 14B may, therefore, be controlled and/or receive instructions from the ECU 102. The memory 106 may, therefore, include user preference profiles 108, threshold data 110, pressure sensing data 112, and displacement models 114. The control system 100 may be configured to issue global commands related to the patient table 10A, 10B or commands to only one or more of the pressure redistribution assembly 14A, 14B.

With reference to FIGS. 1A-8, the weight control system 100 (e.g., the processor 104) may be configured to perform the functions as described herein. For example, the control system 100 may be configured to receive a measurement of the pressure from the pressure sensing assembly 16, determine if the measurement of pressure is above the threshold and, if the measurement of pressure is above the threshold, generate a signal (e.g., to the actuator 26) to redistribute the medium 24 (or move the piezo-electric actuator 64). More particularly, the control system 100 may receive pressure sensing data 112 from the pressuring sensing assembly 16. The control system 100 may further determine if the measurement of pressure is above the threshold by comparing the pressure sensing data 112 to the threshold data 110. The control system 100 may then generate a signal (e.g., to the actuator 26) to redistribute the medium 24 (or move the piezo-electric actuator 64) in accordance with the displacement models 114 and/or other learning algorithms. The user preference profiles 108 may include changing the threshold limits in accordance with specific patient needs. For example, an elderly patient may have a lower pressure tolerance before becoming uncomfortable. Likewise, if certain procedures are being performed, such as surgery, it may be beneficial to put limits on the speed and/or magnitude of the displacement from the repositioning assembly 18A, 18B. In some embodiments, the magnitude of the displacement from the repositioning assembly 18A, 18B is micro-level, such that the displacement encourages circulation and health without being particularly noticeable to a patient or provider.

With continued reference to FIGS. 1A-8, the control system 100 (e.g., the processor 104) may be configured to generate a warning if the measurement of pressure is above the threshold. For example, the control system 100 may generate an audible warning or a visual warning (e.g., on the display 82). The visual warning may include the visualization of the pressure distribution across the matrix of sensing regions 20 with an option to manually control the redistribution. In some embodiments, the control system 100 may be configured to one of continually or periodically monitor the sensed pressure. In some embodiments, the control system 100 may generate a recommendation to reposition the patient before articulating the linkages 36 or the telescopically adjustable central pedestal 42. It is contemplated that, in some embodiments, the pressure redistribution assembly 14A, 14B may not include the repositioning assembly 18A, 18B and instead rely on manual movement by a provider.

The invention disclosed herein is further summarized in the following paragraphs and is further characterized by combinations of any and all of the various aspects described therein.

According to one aspect of the present disclosure, a patient table includes a patient support surface for supporting a patient and at least one pressure redistribution assembly. Each of the at least one pressure redistribution assemblies includes a pressure sensing assembly and a repositioning assembly. The pressure sensing assembly is located proximate to the patient support surface to measure a pressure between the patient support surface and a patient at a plurality of sensing regions. The repositioning assembly includes a plurality of inflatable cells overlapping the plurality of sensing regions. A medium is located within the inflatable cells and an actuator selectively redistributes a quantity of the medium between the inflatable cells. A processor and a memory containing instructions, that when executed by the processor, cause the processor to receive a measurement of the pressure from the pressure sensing assembly. The processor is further caused to determine if the measurement of pressure is above a threshold and, if the measurement of pressure is above the threshold, generate a signal to redistribute the medium.

According to another aspect of the present disclosure, a pressure sensing assembly includes a piezo-resistive layer.

According to yet another aspect of the present disclosure, a pressure sensing assembly includes a top conductive layer and a bottom conductive layer.

According to still another aspect of the present disclosure, a piezo-resistive layer is located between a top conductive layer and a bottom conductive layer.

According to another aspect of the present disclosure, a top conductive layer includes a plurality of rows of conductive pathways and a bottom conductive layer includes a plurality of columns of conductive pathways.

According to yet another aspect of the present disclosure, a plurality of rows of conductive pathways extend transversely to a plurality of columns of conductive pathways and overlap to form sensing regions.

According to still another aspect of the present disclosure, a plurality of rows includes five or more rows of conductive pathways and a plurality of columns includes five or more columns of conductive pathways defining at least 25 sensing regions.

According to another aspect of the present disclosure, a plurality of rows includes eight rows of conductive pathways and a plurality of columns includes eight columns of conductive pathways defining at least 64 sensing regions.

According to yet another aspect of the present disclosure, a medium located within the inflatable cells includes one of air, liquid, or gel.

According to still another aspect of the present disclosure, a threshold includes a magnitude of pressure threshold.

According to yet another aspect of the present disclosure, a threshold further includes a period of time that the measurement of pressure is above a threshold.

According to still another aspect of the present disclosure, an output port and at least one cushion defines a patient support surface. The at least one pressure redistribution assembly is located in the cushion, and a power conduit operably connects the pressure redistribution assembly to the output port.

According to another aspect of the present disclosure, a threshold further includes a period of time that a measurement of pressure is above a magnitude of pressure threshold.

According to another aspect of the present disclosure, the at least one pressure redistribution assembly is substantially radiolucent.

According to yet another aspect of the present disclosure, a mattress defines the patient support surface.

According to still another aspect of the present disclosure, a mattress includes at least one cushion.

According to another aspect of the present disclosure, at least one pressure redistribution assembly is located within the at least one cushion.

According to yet another aspect of the present disclosure, at least one cushion includes an upper cushion layer that is located proximate to a patient support surface and a lower cushion layer that is spaced from a patient support surface by an upper cushion layer.

According to still another aspect of the present disclosure, at least one pressure redistribution assembly is located between an upper cushion layer and a lower cushion layer.

According to another aspect of the present disclosure, an upper cushion layer is adhered to a lower cushion layer with an adhesion layer.

According to yet another aspect of the present disclosure, an upper cushion layer defines a first thickness and a lower cushion layer defines a second thickness that is greater than the first thickness.

According to still another aspect of the present disclosure, at least one pressure redistribution assembly includes two or more pressure redistribution assemblies located in a cushion.

According to another aspect of the present disclosure, at least one cushion includes two or more cushions and at least one pressure redistribution assembly includes a pressure redistribution assembly located in each of the two or more cushions.

According to yet another aspect of the present disclosure, at least one pressure redistribution assembly is located on a top surface of a cushion.

According to still another aspect of the present disclosure, at least one pressure redistribution assembly includes a pad.

According to another aspect of the present disclosure, at least one pressure redistribution assembly is located on a bottom surface of a cushion.

According to another aspect of the present disclosure, a pressure redistribution assembly for a patient includes a pressure sensing assembly and a repositioning assembly. The pressure sensor assembly includes a pair of conductive layers and a piezo-resistive layer sandwiched between the pair of conductive layers. Each conductive layer defines a plurality of conductive pathways that overlap to form a matrix of sensing regions. The repositioning assembly includes a plurality of inflatable cells overlapping the sensing regions, a medium located within the inflatable cells, and an actuator that selectively redistributes a quantity of the medium between the inflatable cells.

According to yet another aspect of the present disclosure, a number of inflatable cells is equal to a number of sensing regions.

According to still another aspect of the present disclosure, each of the sensing regions includes a single one of the inflatable cells aligned therewith.

According to another aspect of the present disclosure, an actuator in a repositioning assembly includes a pump and a manifold of medium pathways.

According to another aspect of the present disclosure, a processor and a memory contain instructions that, when executed by the processor, cause the processor to receive a measurement of pressure from a pressure sensing assembly, determine if the measurement of pressure is above a threshold, and, if the measurement of pressure is above the threshold, generate a signal to redistribute the medium.

According to yet another aspect of the present disclosure, a cushion for a patient in an operating environment includes an outer envelope surrounding the cushion and a patient support surface is defined by a portion of the outer envelope. The cushion includes a pressure redistribution assembly located in the outer envelope. The pressure redistribution assembly includes a pressure sensing assembly and a repositioning assembly. The pressure sensing assembly includes a pair of conductive layers and a piezo-resistive layer sandwiched between the pair of conductive layers. Each conductive layer defines a plurality of conductive pathways that overlap to form a matrix of sensing regions. The repositioning assembly includes a plurality of piezo-electric actuators overlapping the sensing regions that expand and contract from an applied voltage.

According to still another aspect of the present disclosure, an upper cushion layer is located proximate to a patient support surface and a lower cushion layer is spaced from the patient support surface by the upper cushion layer.

According to another aspect of the present disclosure, a pressure redistribution assembly is located between an upper cushion layer and a lower cushion layer.

According to yet another aspect of the present disclosure, a pressure redistribution assembly is located along a top surface of a cushion.

According to still another aspect of the present disclosure, a pressure redistribution assembly is located along a bottom surface of the cushion.

According to yet another aspect of the present disclosure, a cushion has a power conduit extending through an envelope providing power to a pressure redistribution assembly.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A patient table comprising:
a patient support surface for supporting a patient; and
at least one pressure redistribution assembly, each of the at least one pressure redistribution assemblies comprising:
a pressure sensing assembly located proximate to the patient support surface to measure a pressure between the patient support surface and the patient at a plurality of sensing regions;
a repositioning assembly, the repositioning assembly including a plurality of inflatable cells overlapping the plurality of sensing regions, a medium located within the inflatable cells, and an actuator for selectively redistributing a quantity of the medium between the inflatable cells; and
a processor and a memory containing instructions that, when executed by the processor, cause the processor to:
receive a measurement of the pressure from the pressure sensing assembly;
determine if the measurement of pressure is above a threshold; and
if the measurement of pressure is above the threshold, generate a signal to redistribute the medium.

2. The patient table of claim 1, wherein the pressure sensing assembly includes a piezo-resistive layer.

3. The patient table of claim 2, wherein the pressure sensing assembly further includes a top conductive layer and a bottom conductive layer.

4. The patient table of claim 3, wherein the piezo-resistive layer is located between the top conductive layer and the bottom conductive layer.

5. The patient table of claim 4, wherein the top conductive layer includes a plurality of rows of conductive pathways and the bottom conductive layer includes a plurality of columns of conductive pathways.

6. The patient table of claim 5, wherein the plurality of rows of conductive pathways extend transversely to the plurality of columns of conductive pathways and overlap to form the plurality of sensing regions.

7. The patient table of claim 6, wherein the plurality of rows includes five or more rows of conductive pathways and the plurality of columns includes five or more columns of conductive pathways defining at least 25 sensing regions.

8. The patient table of claim 1, wherein the medium located within the inflatable cells includes one of air, liquid, or gel.

9. The patient table of claim 1, wherein the at least one pressure redistribution assembly is substantially radiolucent.

10. The patient table of claim 1, wherein the threshold further includes a period of time that the measurement of pressure is above the threshold.

11. The patient table of claim 1, further including an output port and at least one cushion defining the patient support surface, wherein the at least one pressure redistribution assembly is located in the cushion, and wherein a power conduit operably connects the pressure redistribution assembly to the output port.

12. A pressure redistribution assembly for a patient comprising:
a pressure sensing assembly including a pair of conductive layers and a piezo-resistive layer sandwiched between the pair of conductive layers, each conductive layer defining a plurality of conductive pathways that overlap to form a matrix of sensing regions; and
a repositioning assembly including a plurality of inflatable cells overlapping the sensing regions, a medium located within the inflatable cells, and an actuator for selectively redistributing a quantity of the medium between the inflatable cells.

13. The pressure redistribution assembly of claim 12, wherein the number of inflatable cells is equal to the number of sensing regions.

14. The pressure redistribution assembly of claim 13, wherein each of the sensing regions includes a single one of the inflatable cells aligned therewith.

15. A cushion for a patient in an operating environment comprising:
an outer envelope surrounding the cushion;
a patient support surface defined by a portion of the outer envelope; and
a pressure redistribution assembly located in the outer envelope and comprising:
a pressure sensing assembly including a pair of conductive layers and a piezo-resistive layer sandwiched between the pair of conductive layers, each conductive layer defining a plurality of conductive pathways that overlap to form a matrix of sensing regions; and
a repositioning assembly, the repositioning assembly including a plurality of piezo-electric actuators overlapping the sensing regions that expand and contract from an applied voltage.

16. The cushion of claim 15, further including an upper cushion layer that is located proximate to the patient support surface and a lower cushion layer that is spaced from the patient support surface by the upper cushion layer.

17. The cushion of claim 16, wherein the pressure redistribution assembly is located between the upper cushion layer and the lower cushion layer.

18. The cushion of claim 15, wherein the pressure redistribution assembly is located along a top surface of the cushion.

19. The cushion of claim 15, wherein the pressure redistribution assembly is located along a bottom surface of the cushion.

20. The cushion of claim 15, further including a power conduit extending through the envelope providing power to the pressure redistribution assembly.
